(19) United States
(12) Patent Application Publication
(10) Pub. No.: US 2025/0241219 A1
(43) Pub. Date: Jul. 31, 2025

(54) FOLDING RESIDUE MANAGEMENT TOOL FOR SEEDERS

(71) Applicant: VADERSTAD INDUSTRIES INC., Langbank (CA)

(72) Inventors: Crister STARK, Väderstad (SE); Barry MELANSON, Kennedy (CA)

(21) Appl. No.: 18/854,413

(22) PCT Filed: May 3, 2023
(86) PCT No.: PCT/CA2023/050605

§ 371 Date: Oct. 4, 2024

Related U.S. Application Data
(60) Provisional application No. 63/339,169, filed on May 6, 2022.

(51) Int. Cl. A01B 49/06; A01C 5/06; A01C 7/00

(52) U.S. Cl. CPC A01B 49/06; A01C 5/062; A01C 7/006

(57) ABSTRACT

A residue management tool is provided which is mountable to a frame of a seeder for cutting or clearing residue on the ground. The residue management tool can be engaged with the ground when crop residue is problematic and readily disengaged and placed in a non-working mode when crop residue is manageable, without interrupting seeding/fertilizing.

### TECHNICAL FIELD

The following relates to a folding residue management tool for a seeder useful in, but not exclusively for, no-till farming. More particularly, the folding residue management tool is able to fold into a non-working position when not needed to prevent wear on the tool, thereby extending the working life of the tool.

### BACKGROUND

No-till farming (also called zero tillage or direct drilling) or cover crop farming is a way of growing crops from year to year without disturbing the soil through tillage. No-till is an agricultural technique which increases the amount of water that infiltrates into the soil and increases organic matter retention and cycling of nutrients in the soil. In many agricultural regions it can reduce or eliminate soil erosion. No-till seeding requires seeding into the previous year's crop residue and/or cover crops, which presents a number of challenges to no-till farmers.

Knife openers have become more popular than disc openers in no-till farming for several reasons. One reason is that, when using a disc to open the soil for the seed, the disc often pushes straw into the furrow where the seed is placed instead of cutting it. This is commonly referred to in the industry as “hair-pinning”. Hair-pinning is common when using disc openers because the disc needs to be set to seed shallow. However, the disc needs to be set relatively deep to cut straw instead of hair-pinning it.

Another reason why knives have become popular in no-till farming is that the knives also aerate and warm the soil by leaving a black strip for the seed to germinate in. Knives also leave a small furrow for the seed to grow in, and, therefore, the furrow protects the seedling and stays moist longer than the small groove left by a disc opener. Nevertheless, the use of knife openers in no-till farming may still be problematic when the residue is damp, or has long vines, etc. In these conditions, the knives will rake the straw up and sometimes plug the machine, thereby making seeding with knife openers more difficult. Hence, residue management tools are often used in these situations.

Nevertheless, there still may be situations where the crop residue is such that a residue management tool is not needed. Further, there may be situations during seeding where a residue management tool is only needed for part of the field to be seeded and, in this instance, having a residue tool still operational when in low crop residue conditions may interfere with proper seed/fertilizer placement. However, having to stop mid-seeding to remove a residue tool is laborious and time consuming. Thus, there is a need in the industry for a residue management tool that can be readily engaged when crop residue is problematic and readily disengaged when crop residue is manageable, without interrupting seeding/fertilizing.

### SUMMARY

The following relates to a ground-driven residue management tool to be used in conjunction with any seeding unit for reduced tillage, minimum tillage or no-till seeding.

In particular, a residue management tool is provided to prevent or substantially reduce seeding equipment plugging in heavy crop residue conditions, which tool can also be readily folded away when seeding in light crop residue conditions. In addition to other advantages, folding the residue tool into a non-working position when not needed will prevent wear on the tool, thereby extending the working life of the tool. Hence, in one aspect, a residue management tool mountable to a frame of a seeder for cutting or clearing residue on the ground is provided, comprising:
a parallel link having a proximal end and a distal end, the parallel link comprising upper and lower substantially parallel arm members, the proximal end of the parallel link adapted to be directly or indirectly pivotally attached to the frame;
a rotatable cutting or clearing device operably mounted to the distal end of the parallel link and operative to cut or clear the residue on the ground; and
a biasing device operative to exert a downward bias force on the pivotable parallel link of the residue management tool to engage the rotatable cutting or clearing device with the ground when in a working mode and to exert an upward force on the parallel linkage of the residue management tool to disengage the rotatable cutting or clearing device with the ground when in a non-working or a transport mode.

In one embodiment, the residue management tool further comprises a depth restraint operative to prevent the rotatable cutting or clearing device from over-penetrating the ground. In one embodiment, the biasing device is a hydraulic cylinder, which, when fully extended, exerts the downward bias force and, when fully retracted, allows the residue management tool to stop in its non-working or transport mode. In another embodiment, the residue management tool may further comprise a physical stopper so that, when the biasing device exerts the upward force, the residue management tool can move upward to bear against the stopper.

In one embodiment, the proximal end of the parallel link is pivotally attached to a plate which is rigidly attached to a hanging bracket which is then attached to the frame. In one embodiment the rotatable cutting or clearing device is a disc or a rake. In one embodiment, the plate is attached to the hanging bracket such that the plate is angled relative to the ground. In one embodiment, the plate is angled about 80 degrees relative to the ground such that the residue management tool is angled inwardly. In one embodiment, the plate is angled relative to the ground but the rotatable cutting or clearing device remains perpendicular to the ground.

In a second aspect, a ground opening implement mountable to a frame of a seeder is provided, comprising:
a ground opener assembly comprising an elongated main member having a first end pivotally mountable directly or indirectly to the frame and a second end;
a first dispensing opener for dispensing a first material to a first depth in the ground mounted to the elongated main member between the first and second ends;
a ground compressing and gauging member mounted to the second end of the elongate main member;
a residue management tool comprising a rotatable cutting or clearing device mountable directly or indirectly to the frame such that the rotatable cutting or clearing device is positioned in front of the first dispensing opener;
a first biasing assembly operative to exert a downward bias force on the residue management tool to engage the rotatable cutting or clearing device with the ground when in a working mode and to exert an upward force on the residue management tool to disengage the rotatable cutting or clearing device with the ground when in a non-working or a transport mode; and
a second biasing assembly operative to exert a downward bias force on the first dispensing opener to engage the first dispensing opener with the ground when in a working mode and to exert an upward force on the first dispensing opener to disengage the first dispensing opener with the ground when in a transport mode;
   whereby the depths of both the residue management tool and the first dispensing opener in the ground are controlled by the ground compressing member.

In one embodiment, the rotatable cutting or clearing device is a disc or a rake. In one embodiment, when the residue management tool is in the non-working or transport mode, the residue management tool is positioned to the side of the elongated main member.

In one embodiment, the ground opener assembly further comprises a second dispensing opener for dispensing a second material to a second depth in the ground mounted to the elongated main member at the second end such that the second dispensing opener is positioned between the first dispensing opener and the ground compressing member. In this embodiment, the second biasing assembly is operative to exert a downward bias force on both the first and second dispensing openers to engage both the first and second dispensing openers with the ground when in a working mode and to exert an upward force on both the first and second dispensing openers to disengage the first and second dispensing openers with the ground when in a transport mode. Further, in this embodiment, the ground compressing member also controls the depth of the second dispensing opener.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic side view of one embodiment of a residue management tool of the present invention and a ground opener assembly (collectively a ground opening implement) in operation on flat ground.

FIG. 2A is a schematic top view of the ground opening assembly of FIG. 1.

FIG. 2B is a schematic front view of the ground opening implement of FIG. 1.

FIG. 3 is a schematic side view the ground opening implement of FIG. 1 where the residue management tool is in a folded or non-working position.

FIG. 4A is a schematic top view of the ground opening implement of FIG. 3.

FIG. 4B is a schematic front view of the ground opening implement of FIG. 3.

FIG. 5 is a schematic side view of the ground opening implement of FIG. 1 in the transport position.

FIG. 6A is a schematic top view of the ground opening implement of FIG. 5.

FIG. 6B is a schematic front view of the ground opening implement of FIG. 5.

FIG. 7 is a schematic side view of another embodiment of a residue management tool of the present invention and a ground opener assembly (collectively a ground opening implement) in operation on flat ground.

### DETAILED DESCRIPTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

There is a need in the industry for a residue management tool that may be attached to the frame of a seeder which can engage the ground when seeding in high residue conditions but which can be disengaged from the ground (i.e., folded) when seeding in low residue conditions without interrupting the seeding process. The tool comprises a rotatable cutting or clearing device such as disc, rake or other row cleaner mounted on the frame of the seeder that would either cut residue or clear the residue to the side while running in front of a ground opener assembly comprising, for example, at least one knife opener. The residue management tool should not affect the precision, packing or penetrating forces of the independent depth controlled ground opener assembly, generally controlled by a ground compressing member, and, preferably, it would still use the ground compressing member (e.g., packer wheel) for depth control to maintain the depth of the rotatable cutting or clearing device.

The residue management tool further comprises a biasing device (e.g., a hydraulic cylinder) to provide the penetrating forces needed for cutting/clearing residue when engaged in the ground but can also lift the residue management tool away from the ground when not required. Thus, the biasing devise allows the residue management tool to move into a working position and a folded position.

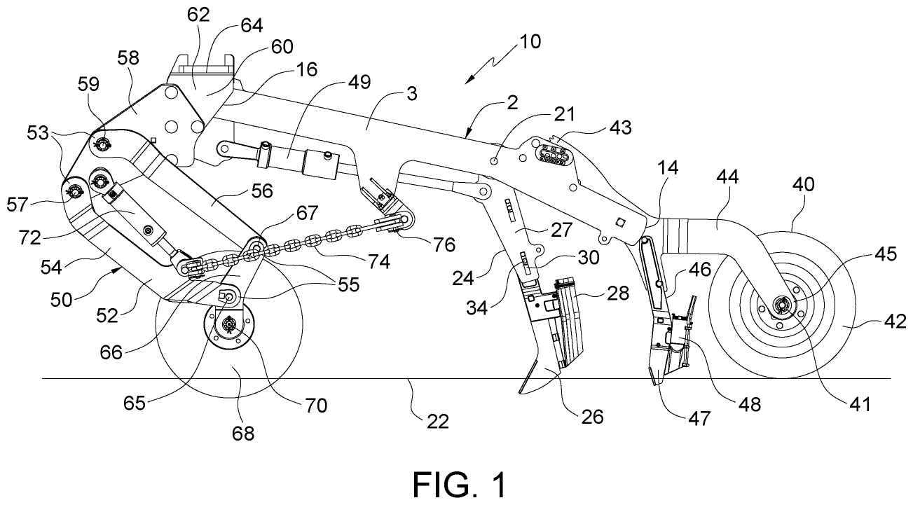

With reference now to FIG. 1, a side view of a ground opening implement 10 having one embodiment of a residue management tool 50 is shown, which residue management tool 50 is adapted to attach to the frame of a seeder (frame not shown). Further attached to the frame of the seeder is a ground opener assembly 2 comprising two openers (i.e., a dual material dispensing ground opener assembly). Collectively, a residue management tool and a ground opener assembly are referred to herein as a ground opening implement. It is understood, however, that the ground opener assembly may only comprise a single opener. FIG. 1 shows the ground opening implement 10 in the working position, whereby both the residue management tool 50 and the ground opener assembly 2 are engaged with ground 22.

In the embodiment shown in FIG. 1, residue management tool 50 comprises a parallel link 52 having a proximal end 53 and a distal end 55. Parallel link 52 comprises an upper arm member 56 and a lower arm member 54, which arms are substantially parallel to one another. Proximal end 53 of parallel link 52 is adapted to be pivotally mounted directly or indirectly to the frame of a seeder. In one embodiment, parallel link 52 is pivotally attached to a plate 58 by means of a first proximal pivot pin 57 and a second proximal pivot pin 59, each of which pivotally attaches one end of lower arm member 54 and one end of upper member 56, respectively, to plate 58. Plate 58 is attached to mounting device 60 by any fastening means, for example, at least one bolt. Mounting device 60 comprises hanging bracket 62 and clamp 64 and is mounted to the frame of the seeder (not shown).

The distal end of parallel link 52 is attached to mounting arm 66 by means of a first distal pivot pin 65 and a second distal pivot pin 67, each of which pivotally attaches the other end of lower arm member 54 and the other end of upper member 56, respectively, to mounting arm 66. Also attached to mounting arm 66 by means of axle 70 is a rotatable cutting or clearing device, which is shown in this embodiment as disc 68. Disc 68 will move from left to right as the ground changes, which will be explained in more detail below. It is understood, however, that other rotatable cutting or clearing devices can also be used. For example, there may be instances where the residue may be too high to be effectively cut. Thus, a row cleaner such as a tined row cleaner (e.g., a rake) can be used which moves the residue out of the row ahead of the ground openers. The parallel link forms a parallelogram which configuration allows the rotatable cutting or clearing disc to remain in a vertical (perpendicular) position relative to the ground, both when the residue management tool is in the working position and when the residue management tool is in the folded, non-working or a transport mode, which will be described in more detail below.

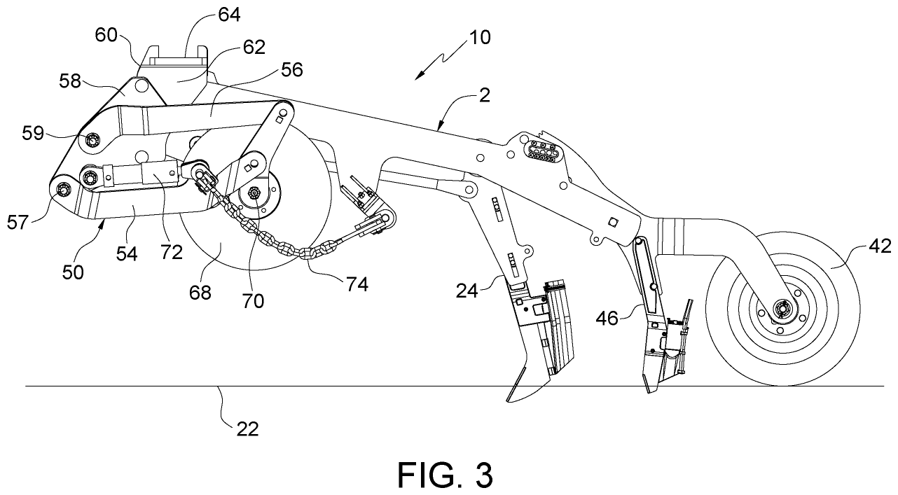

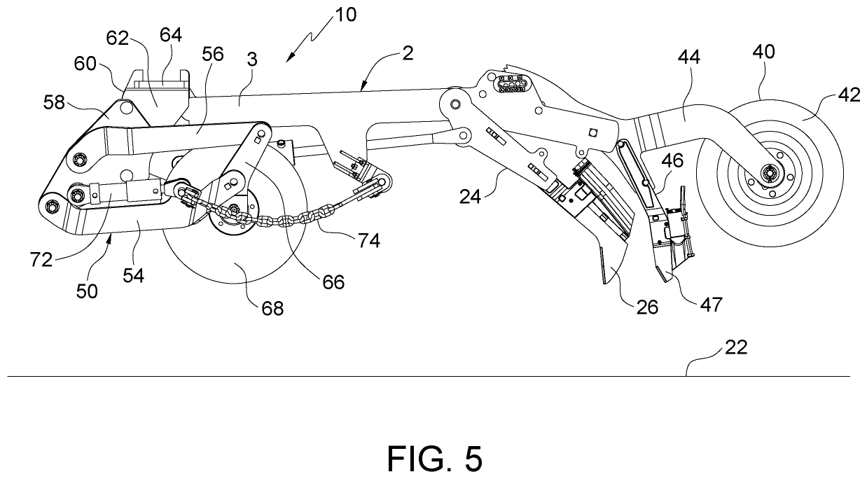

Residue management tool 50 further comprises a biasing device, which is shown in FIG. 1 as hydraulic cylinder 72. One end of hydraulic cylinder 72 is attached to plate 58 and the other end is attached to the lower arm member 54 near its distal end. The hydraulic cylinder exerts force on the rotatable cutting disc 68 when the residue management tool 50 is in the working position (hydraulic cylinder 72 extended as shown in FIG. 1) and retracts when the residue management tool 50 is in the folded, non-working position (FIG. 3) or the folded, transport position (FIG. 5). Hydraulic lines (not shown) are connectable to cylinder ports which control the extension and retraction of the cylinder to maintain the biasing force on the residue management tool 50.

Residue management tool 50 further comprises a depth restraint 74 operative to prevent the rotatable cutting disc 68 from over-penetrating the ground. Depth restraint 74 further comprises a working depth adjustment device 76, which will be described in more detail below. In the embodiment shown in FIG. 1, depth restraint 74 comprises a chain which is attached to lower arm member 54 at one end and elongated main member 3 at the other end. It is understood, however, that other means for gauging depth can also be used. In one embodiment, the residue management tool further comprises a gauge wheel for maintaining the rotatable cutting disc at a constant depth. The gauge wheel may be made of rubber, polyurethane, or other materials known in the art. In one embodiment the gauge wheel is spaced from and parallel to the rotatable cutting disc.

At least one ground opener assembly 2 is mounted to a conventional frame (not shown) via mounting device 60 comprising clamps 64 and hanging bracket 62. Assembly 2 comprises an elongated main member 3 having a proximal end 16 and a distal end 14. Proximal end 16 of elongated main member 3 is pivotally mounted to hanging bracket 62 (pivotal mounting not shown).

A first dispensing opener (or knife opener) 24 for dispensing a first material, such as fertilizer, to a first depth in the ground 22 is pivotally mounted to elongated main member 3 by pivot bolt 21. In the illustrated embodiment, the first dispensing opener 24 includes a pivot bracket 27 and a knife 26 (also referred to as a fertilizer knife) attached to its distal end for forming a first furrow in the ground 22. In FIG. 1, knife 26 is shown penetrating ground 22 to create a first furrow. Immediately behind knife 26, there is a tube holder 28 for carrying a supply tube that deposits a first material, in this case fertilizer, into the first furrow from a supply source (not shown). Such a supply tube is conventional. Preferably, knife 26 is mounted to pivot bracket 27 to allow for independent adjustment of depth by depth adjuster 30. In the illustrated embodiment, this involves knife 26 being mounted to the downwardly extending pivot bracket 27 via at least one bolt movable in slot 34 formed in the pivot bracket 27 to adjust the vertical position of the knife 26. Once the vertical position of the knife 26 is determined, the at least one bolt can be tightened so that knife 26 remains in position.

Also attached at or near the distal end 14 of elongated main member 3 is mounting arm 44. Attached to the distal end 45 of mounting arm 44 is a ground compressing and gauging member (ground compressor) 40 comprising a wheel element 42, (e.g., a packer wheel). Wheel element 42 is rotatably mounted to mounting arm 44 by an axle and bearings 41 to permit free rotation of the wheel element over the ground 22. The vertical position of the ground compressing and gauging member 40 can be adjusted via slot 43.

A second dispensing opener or seed opener 46 for dispensing a second material, such as seed, to a second depth different than the depth of the first dispensing opener is also mounted to mounting arm 44. In the illustrated embodiment, the second dispensing opener 46 includes a knife 47 (also referred to as a seed knife) for forming a second furrow in the ground 22. Knife 47 is shown penetrating ground 22 to create a second furrow. Immediately behind knife 47, there is a tube holder 48 for carrying a supply tube that deposits a second material, in this case seed, into the second furrow from a supply source (not shown). Such a supply tube is conventional.

As shown in FIG. 1, the second dispensing opener 46 is mounted to be laterally offset from first dispensing opener 24 in order to laterally space the first and second furrows according to recommended agronomic practice. Ground compressor 40 is positioned such that it can perform its packing function of packing the first and second furrows. While a wheel element 42 has been shown in the drawing, a person skilled in the art will understand that alternative ground compressing members are possible such as a skid. Thus, it can be seen from FIG. 1 that the ground compressing and gauging member 40 acts as a gauge for the residue management tool 50, the first opener 24 and the second opener 46.

The ground opener assembly 2 of the present embodiment is provided with a biasing system to exert a ground penetrating force to the first and second dispensing openers 24 and 46, respectively, and a compressing force to the ground compressor 40 instead of relying on gravity. In the illustrated arrangement, the biasing system comprises an adjustable hydraulic cylinder 49. At one end, hydraulic cylinder 49 is pivotally mounted to hanging bracket 62. At the other end, hydraulic cylinder 49 is pivotally connected to pivot bracket 27 of first dispensing opener 24. Hydraulic lines (not shown) are connectable to cylinder ports which control the extension and retraction of the cylinder to maintain the biasing force on the first and second dispensing openers 24 and 46, respectively, and the ground compressor 40. Hydraulic cylinder 76 preferably includes an adjustable overload pressure valve whereby an excess force applied to the first dispensing opener 24 will activate the valve to release the excess pressure allowing opener 24 to pivot rearwardly about pivot bolt 21. This provides a trip release mechanism to permit pivoting of the first dispensing opener 24 out of the way of an obstacle encountered in the ground.

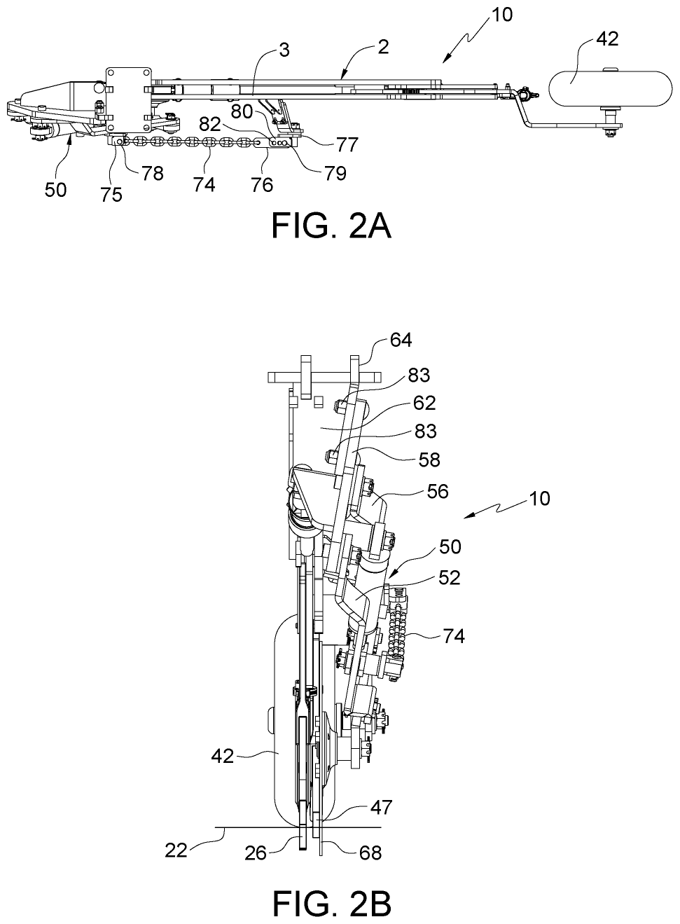

FIG. 2A is a top view of the ground opening implement 10 of FIG. 1, which shows working depth adjustor 76 of residue management tool 50 in more detail. As can be seen from FIG. 2A, a first end of depth restraint (chain) 74 is attached to lower arm member 54 via a small first bracket 75 and a first bolt 78, and a second end is attached to elongated main member 3 via a second small bracket 77 and a second bolt 79. The second end further comprises a plate 80 having a number of holes 82 such that bolt 79 can be inserted into any one of the holes 82 to adjust the length of the depth restraint (chain) 74. Thus, the depth of the residue management tool into the ground 22 can be adjusted depending upon the conditions, e.g., amount of residue, of the field being seeded. It can be further seen in FIG. 2A that when residue management tool 50 is in the working position, it is spaced apart from elongated main member 3 and the dispensing opener attached thereto.

FIG. 2B is a front view of ground opening implement 10 of FIG. 1, which shows the front view of the residue management tool 50. As can be seen in FIG. 2B, plate 58 is slanted inwardly at an angle, for example, a 10 degree angle, to allow for clearance of the residue management tool 50 from the ground opener assembly 2 when it is put into either the non-working position or the transport position. It can be seen that plate 58 is bolted to hanging bracket 62 via a number of bolts 83. In FIG. 2B, the rotating disc 68 is in front of both first knife 26 and second knife 47. Packer wheel 42 trails all three and acts as both a depth gauge for the disc 68, knife 26 and knife 47, as well as packing furrows created by knives 26 and 47. Thus, it can be seen in FIG. 2B that plate 58 is at a compound angle to the ground/ground opener assembly center line rather than 90 deg (90 deg would mean the disc 68 moves up/down perpendicular to the ground 22, along the center line of the ground opener assembly).

With the plate 58 at an angle, it shifts the parallel arms 54, 56 to rotate in a different plane than the ground opener assembly 2. This different plane means that as the parallel arms 54, 56 move up/down, the disc 68 is moving left/right relative to the center line of the ground opener assembly 2.

Hence, disc 68 can remain vertical in all left/right positions it sees on its range of motion. The geometry of plate 58 and parallel arms 54, 56 is also important for successfully folding residue management tool 50. It allows the disc 68 to move out of the way of the openers 24, 46 while the openers 24, 46 are operational. In this way, the openers 24, 46 can undulate without worry of interference. For example, when trying to maintain +/−8″ of travel/ground following, there is a lot of motion where interference needs to be avoided. With the gauge wheel 42 behind the residue management tool 50, the openers 24, 46 and disc 68 will be reacting to depth changes at different times. Hence, if the disc 68 were not on a parallel link (parallel arms 54, 56), then the disc angle would change and not stay vertical. It is important to maintain the position/straightness of the disc 68.

FIG. 3 is a side view of the ground opening implement 10 of FIG. 1, where the residue management tool 50 is shown in the folded position. Hydraulic cylinder 72 is retracted, which, in turn, lifts the residue management tool 50 from the ground 22 into a folded position, while the ground opener assembly 2 is still operational. In particular, both first opener 24 and second opener 46 are still engaged in ground 22. Further, wheel element 42 of ground compressor 40 is still on the ground 22 to act as a gauge and packer for the first and second openers.

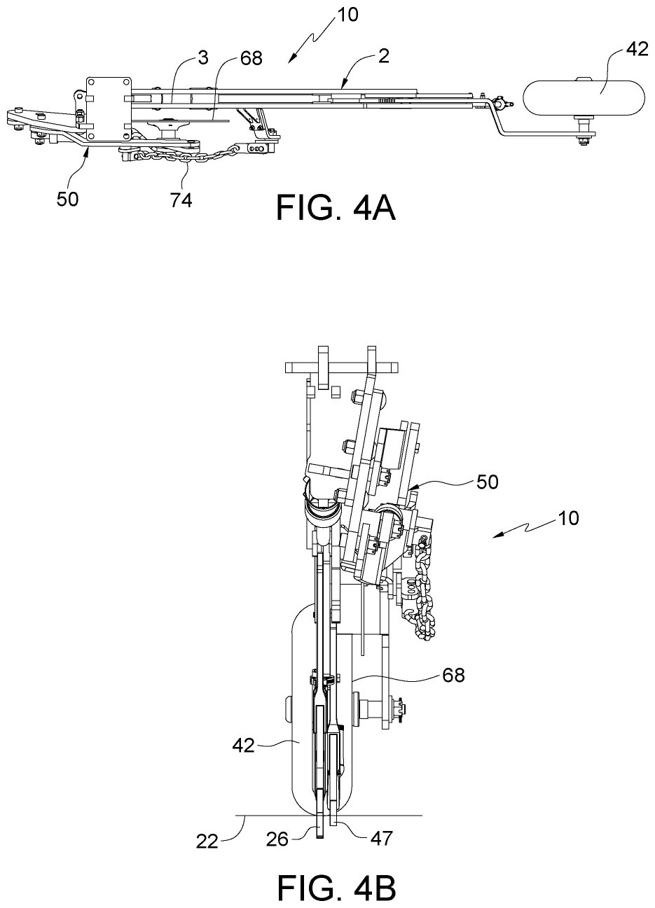

FIG. 4A is a top view of the ground opening implement 10 of FIG. 3, where the residue management tool 50 is shown in the folded position (non-working or a transport mode). As can be seen in FIG. 4A, the residue management tool 50 is able to fold in such a fashion that it is at a significant clearance distance from the ground opener assembly 2. In particular, it can be seen that disc 68 is about 1.7 inches away from the ground opener assembly 2 and therefore does not interfere in the operation of ground opener assembly 2 when seeding under low residue conditions. The use of a parallel link ensures that the disc 68 remains vertical to the ground when being lifted into the folded position, thereby ensuring that the disc 68 does not contact the ground opener assembly 2.

FIG. 4B is a front view of ground opening implement 10 of FIG. 3, where only the residue management tool 50 is lifted off the ground 22 (i.e., folded). FIG. 4B shows that both the fertilizer knife 26 and the seed knife 47 are still engaged in ground 22, while disc 68 of residue management tool 50 is no longer engaged with the ground 50. Further, wheel element 42 is still on the ground 22 to act as a gauge and packer.

FIG. 5 is a schematic side view of ground opening implement 10 in the transport position, i.e., lifted off ground 22 and ready to be transported to a new location. As can be seen in FIG. 5, both residue management tool 50 and ground opener assembly 3 are lifted off ground 22, hence, each of disc 68, knife 26, knife 47 and packer wheel 42 are also lifted at least 12 inches from the ground 22 for easy transportation.

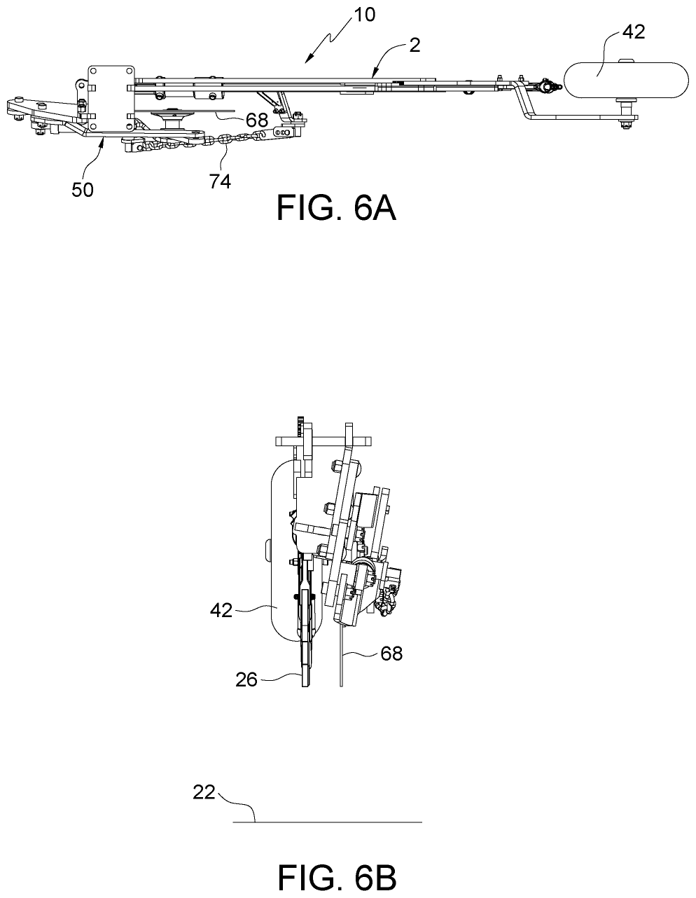

FIG. 6A is a top view of the ground opening implement 10 of FIG. 5, where both the residue management tool 50 and grounder opener assembly 2 are shown in the folded position for transport. As can be seen in FIG. 6A, even when the ground opening implement 10 is in the transport position, where both the residue management tool 50 and the ground opener assembly 3 are lifted off the ground, the residue management tool 50 is still able to fold in such a fashion that it is at a significant clearance distance from the ground opener assembly 2. In particular, it can be seen that disc 68 is about 1.7 inches away from the ground opener assembly 2.

FIG. 6B is a front view of ground opening implement 10 of FIG. 5, where both the residue management tool 50 and grounder opener assembly 2 are lifted off the ground 22 (i.e., folded). FIG. 6B shows that the disc 68 and the fertilizer knife 26 are no longer engaged with ground 22 (seed knife 47 is also not engaged with ground 22 but is shown that it is obscured from view due to fertilizer knife 26). Further, wheel element 42 is also lifted from the ground 22. FIG. 6B clearly shows that in the transport position, disc 68 is significantly spaced apart from knife 26.

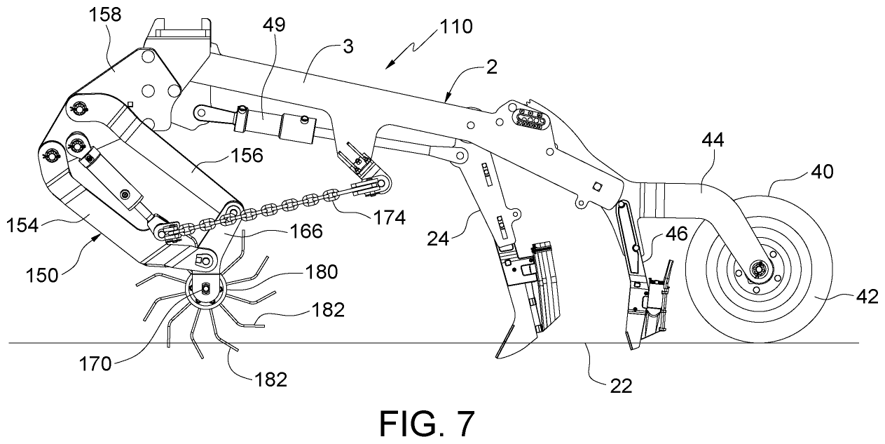

FIG. 7 is a side view of another embodiment of a ground opening implement of the present invention. In this embodiment, ground opening implement 110 of FIG. 7 comprises a ground opener assembly 3, as described above in FIG. 1. However, in this embodiment, instead of a disc, residue management tool 150 comprises rake 180. Rake 180, in turn, comprises a plurality of tynes 182 for raking up residue on ground 22. Residue management tool 150 further comprises a parallel link comprising upper arm 156 and lower arm 154, which arms are substantially parallel to one another. Parallel link is pivotally attached to plate 158 at one end, which plate 158 is also at a compound angle to the ground/ground opener assembly center line rather than 90 deg and to mounting arm 166 at its opposite end. Rake 180 is attached mounting arm 166 by means of axle 170.

### Interpretation

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention. The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50 percent” can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed:

1. A residue management tool mountable to a frame of a seeder for cutting or clearing residue on the ground, comprising:
a parallel link having a proximal end and a distal end, the parallel link comprising upper and lower substantially parallel arm members, the proximal end of the parallel link adapted to be directly or indirectly pivotally attached to the frame;
a rotatable cutting or clearing device operably mounted to the distal end of the parallel link and operative to cut or clear the residue on the ground; and
a biasing device operative to exert a downward bias force on the pivotable parallel link of the residue management tool to engage the rotatable cutting or clearing device with the ground when in a working mode and to exert an upward force on the parallel linkage of the residue management tool to disengage the rotatable cutting or clearing device with the ground when in a non-working or a transport mode.

2. The residue management tool of claim 1, wherein the proximal end of the parallel link is pivotally attached to a plate.

3. The residue management tool of claim 2, wherein the plate is angled less than 90 degrees relative to the ground.

4. The residue management tool of claim 3, wherein the plate is angled about 80 degrees relative to the ground so that the residue management tool is angled inwardly.

5. The residue management tool of claim 3, whereby, when the residue management tool is in the working, non-working or transport mode, the rotatable cutting or clearing device is perpendicular to the ground.

6. The residue management tool of claim 1, further comprising a depth restraint operative to prevent the rotatable cutting or clearing device from over-penetrating the ground.

7. The residue management tool, wherein the depth restraint is a chain which is attached to lower arm member

8. The residue management tool, wherein the depth restraint is a gauge wheel.

9. The residue management tool of claim 1, wherein the biasing device is a hydraulic cylinder and whereby when the hydraulic cylinder is fully extended, it exerts the downward bias force and, when the hydraulic cylinder is fully retracted, it allows the residue management tool to stop in its non-working or transport mode.

10. The residue management tool of claim 2, wherein the plate is attached to a hanging bracket that is adapted to attach to the frame.

11. The residue management tool of claim 1, wherein the rotatable cutting or clearing device is a disc or a rake.

12. A ground opening implement mountable to a frame of a seeder is provided, comprising:
a ground opener assembly comprising an elongated main member having a first end adapted to be pivotally mountable directly or indirectly to the frame and a second end;
a first dispensing opener for dispensing a first material to a first depth in the ground mounted to the elongated main member between the first and second ends;
a ground compressing and gauging member mounted to the second end of the elongate main member;
a residue management tool comprising a rotatable cutting or clearing device and adapted to be pivotally mountable directly or indirectly to the frame such that the rotatable cutting or clearing device is positioned in front of the first dispensing opener;
a first biasing assembly operative to exert a downward bias force on the residue management tool to engage the rotatable cutting or clearing device with the ground when in a working mode and to exert an upward force on the residue management tool to disengage the rotatable cutting or clearing device with the ground when in a non-working or transport mode; and
a second biasing assembly operative to exert a downward bias force on the first dispensing opener to engage the first dispensing opener with the ground when in a working mode and to exert an upward force on the first dispensing opener to disengage the first dispensing opener with the ground when in a transport mode;
whereby the depths of both the residue management tool and the first dispensing opener in the ground are controlled by the ground compressing member.

13. The ground opening implement of claim 12, wherein the residue management tool is pivotally attached to a plate.

14. The ground opening implement of claim 13, wherein the plate is angled less than 90 degrees relative to the ground.

15. The ground opening implement of claim 14, wherein the plate is angled about 80 degrees relative to the ground so that the residue management tool is angled inwardly.

16. The ground opening implement of claim 15, whereby the rotatable cutting or clearing device remains perpendicular to the ground.

17. The ground opening implement of claim 12, wherein the residue management tool further comprises a depth restraint operative to prevent the rotatable cutting or clearing device from over-penetrating the ground.

18. The ground opening implement of claim 13, wherein the plate is attached to a hanging bracket that is adapted to attach to the frame.

19. The ground opening implement of claim 12, wherein the rotatable cutting or clearing device is a disc or a rake.

20. The ground opening implement of claim 12, whereby when the residue management tool is in the non-working or transport mode, the residue management tool is positioned to the side of the elongated main member.

21. The ground opening implement of claim 12, wherein the ground opener assembly further comprises a second dispensing opener for dispensing a second material to a second depth in the ground mounted to the elongated main member at the second end such that the second dispensing opener is positioned between the first dispensing opener and the ground compressing member.

22. The ground opening implement of claim 21, wherein the second biasing assembly is operative to exert a downward bias force on both the first and second dispensing openers to engage both the first and second dispensing openers with the ground when in a working mode and to exert an upward force on both the first and second dispensing openers to disengage the first and second dispensing openers with the ground when in a transport mode.

23. The ground opening implement of claim 21, wherein the ground compressing member also controls the depth of the second dispensing opener.
